(19) United States
(12) Patent Application Publication
(10) Pub. No.: US 2019/0365157 A1
(43) Pub. Date: Dec. 5, 2019

(54) DEVICE FOR GRIPPING AN OBJECT, TONG CONFIGURATION AND METHOD FOR GRIPPING A FOOD ITEM

(71) Applicant: RICHARD KLEINOFEN, DUESSELDORF (DE)

(72) Inventor: RICHARD KLEINOFEN, DUESSELDORF (DE)

(21) Appl. No.: 16/543,789

(22) Filed: Aug. 19, 2019

Related U.S. Application Data
(63) Continuation of application No. PCT/EP2018/053857, filed on Feb. 16, 2018.

(30) Foreign Application Priority Data
Feb. 17, 2017 (DE) 10 2017 103 291.6

(51) Int. Cl. A47J 43/28; A47J 37/07; A23L 5/10

(52) U.S. Cl. CPC A47J 43/283; A23V 2002/00; A23L 5/15; A47J 37/0786

(57) ABSTRACT

A device for gripping and rotating an object includes two tong legs which are interconnected at a point of articulation, a gear mechanism which is connected to both of the tong legs and an actuation element which is connected to the gear mechanism. A first translational movement of the actuation element is converted by the gear mechanism in such a way that the tong legs can pivot towards one another and can be rotated about a rotational axis that includes the point of articulation. A tong configuration and a method for using a tong configuration are also provided.

### CROSS-REFERENCE TO RELATED APPLICATION

This is a continuation application, under 35 U.S.C. § 120, of copending International Application PCT/EP2018/053857, filed Feb. 16, 2018, which designated the United States; this application also claims the priority, under 35 U.S.C. § 119, of German Patent Application DE 10 2017 103 291.6, filed Feb. 17, 2017; the prior applications are herewith incorporated by reference in their entirety.

### BACKGROUND OF THE INVENTION

### Field of the Invention

The invention relates to a device for gripping and rotating an object. The invention relates in particular to a device for gripping and rotating food for grilling. The invention also relates to a tong configuration and a method for gripping a food item.

Tools such as tongs for handling objects can be used in various fields. Tongs are used in particular for gripping objects. In the area of foods, it is known that foods on a grill can be gripped and moved by using grilling tongs. However, most of the known devices for gripping objects make it possible to carry out a gripping action and thus allow only very limited handling. The objects gripped are then moved manually, for example, by moving the user's arm. That can result in an unwanted burden for the user. In many applications, it is also very time-consuming to move the gripped objects manually. Furthermore, manual movement of the gripped objects is usually subject to error and is not adequately reproducible.

### SUMMARY OF THE INVENTION

It is accordingly an object of the invention to provide a device for gripping an object, a tong configuration and a method for gripping a food item, which overcome the hereinafore-mentioned disadvantages and solve and/or at least reduce the technical problems of the heretofore-known devices and methods of this general type. In particular, a device for gripping an object (in particular food for grilling) is to be presented, permitting a particularly flexible, reliable and efficient handling of the object.

The features listed individually in the claims can be combined with one another in any manner that makes technological sense and can be supplemented by explanatory content from the Specification, wherein additional structural variants of the invention are presented.

With the foregoing and other objects in view there is provided, in accordance with the invention, a device for gripping and rotating an object, comprising at least the following:
two tong legs joined together at an articulation point,
a gear mechanism connected to the two tong legs, and
an actuating element, which is connected to the gear mechanism,
wherein a first translational movement of the actuating element is converted by the gear mechanism in such a way that the tong legs can be pivoted relative to one another and can be rotated about an axis of rotation that includes the articulation point.

It is possible to grip and rotate an object by using this device. For example, it may be used for turning the food for grilling. With elongated food for grilling in particular, for example, bratwurst or hot dogs, it is preferable for the food for grilling to be rotatable about its axis. In other applications, it may also be necessary to rotate an object that is gripped. Manual rotation of the gripped object could take place in the past by using a rotational movement using one's wrist, for example. In particular, such a rotational movement with a person's wrist can result in complaints when repeated frequently. Such complaints may include, for example, fatigue phenomena and/or tendonitis in the wrist. In addition, it may be difficult for the elderly or the disabled to carry out such a rotational movement with their wrists. By using the device described herein, it is possible to omit such a rotational movement of the wrist in many applications. Since manual rotation of the object being gripped is not necessary when using the device according to the invention, the rotational movement (executed automatically) can also be achieved in a particularly reliable and reproducible manner. Thus, for example, an object that is gripped can be rotated by an angle predetermined by the construction of the device, with that angle being the same with each repetition of this movement. Furthermore, an object can be held especially securely by this device by being rotated. Furthermore, this device also permits particularly rapid and accurate handling of objects.

The device has two tong legs in particular for gripping an object. The tong legs are preferably constructed like rods. The tong legs are preferably joined at the articulation point in the manner of tongs and can be pivoted with respect to one another. Each tong leg preferably has a gripping end by which the object can be gripped. Each tong leg preferably has a gripping jaw on the gripping end. The two gripping jaws can be moved toward one another to clamp the object or the food for grilling between them (closing process). The two gripping ends may also be moved away from one another to release an object or food for grilling located between them (opening process). In addition, each tong leg preferably has a guide end, on which the tong legs are guided in the gear mechanism. In particular, the gripping ends and the guide ends represent opposing ends of the tong legs with respect to the articulation point. The tong legs can be pivoted toward one another and rotated by the movement acting on them by using the joint. The phrase “pivoting of the tong legs” is understood in particular to refer to closing (for gripping an object) or opening (for releasing an object) the gripping ends of the tong legs. The tong legs are rotated about the axis of rotation. At any rate, the axis of rotation runs through the articulation point. It is preferable for the axis of rotation to be situated in a plane spanned by the tong legs. Additionally or alternatively, it is preferable for the axis of rotation to run centrally between the gripper ends. It is preferable in particular for the axis of rotation to lie in a plane of the tong legs, to run through the articulation point, and to run centrally between the gripping ends of the tong legs. Therefore, an elongated object, such as a bratwurst or hot dog, can be rotated about its axis. In this case in particular, the device is especially suitable for turning food for grilling, in particular for turning bratwurst or hot dogs.

The tong legs are preferably constructed to be substantially straight. Alternatively, however, it is also preferable for the tong legs to be constructed with a (partial) bend and/or a (local) kink. The kink is preferably disposed at or adjacent the articulation point. It is thus possible in particular to achieve an especially compact construction of the device.

The tong legs are connected to a gear mechanism. The gear mechanism is to be understood in this case in particular to refer to a device, which is intended and equipped to convert a movement of the actuating member into a movement of the tong legs. A person using the device can operate the actuating element in particular and can thus pivot and rotate the tong legs. The actuating element may preferably be an actuating rod. The term “actuation” is to be understood in particular to mean that the user moves the actuating element in a translational (and/or axial) movement. In order to do so, it is not necessary for the user to move the actuating element directly. The user may instead also move the actuating element indirectly (by way of other components of the device). The gear mechanism is in particular a (purely) mechanical gear mechanism. A mechanical gear mechanism converts the movement initiated by an actuator (the actuating element in this case) into a different movement of an actuator (the tong legs in this case) without any electrical or electronic components participating directly in the conversion of the movement. The movement of the actuator and that of the actuator differ from one another at least with regard to one of these properties: orientation or speed. The gear mechanism can (partially) carry out both movements of the actuator and the actuator. In the case of a mechanical gear mechanism, for example, gear wheels, toothed racks, joints, slotted guides and the like are preferably provided, with these parts causing the conversion of the movement (solely). The actuating element is preferably rigidly connected to the gear mechanism, while the guide ends of the tong legs are movable and/or displaceable with respect to the gear mechanism and/or in the gear mechanism. This gear mechanism is constructed and equipped in particular, so that a translational movement initiated by using the actuating element is converted into a pivoting movement and/or a rotational movement of the tong legs.

The actuating element can be moved with a first translational movement and with a second translational movement. The first translational movement in this case is to be understood as any translational movement in a first direction of movement. The second translational movement is to be understood in this case as any translational movement in a second direction of movement, in such a way that the second direction of movement is opposite the first direction of movement. In particular, the actuating element can carry out (only) a first translational movement toward and/or into the gear mechanism and a second translational movement away from and/or out of the gear mechanism. The translational (and/or axial) movement may run parallel to the axis of rotation or may coincide with the axis of rotation, relatively.

The tong legs are preferably at least partially interchangeable. For example, a plug connection to which various attachments for different applications can be attached may be provided on the tong legs for this purpose. The attachment may also be removed and cleaned independently of the remaining device. The attachments may include the gripping ends or may be disposed there. The tong legs may be positioned (temporarily) in a fixed position relative to one another with a closing element, for example, in a closed position. The closing element may reach around opposing sections of the tong legs, for example, between the joint and the gripping ends, at least partially, and may have a (mechanical) closure, which can be activated or deactivated by the user as needed. The tong legs may be formed by a metallic (base) material. It is also possible for the tong legs to be formed (at least partially) by another metal, for example, in a section positioned at a distance from the gripping jaws (in particular in the manner of a surface coating).

With this device, the tong legs may be pivotable relative to one another by a second translational movement opposite the first translational movement of the actuating element without rotation.

The tong legs can preferably be closed and rotated by the first translational movement and can be opened by the second translational movement (without rotation). The tong legs can be closed and rotated by the first translational movement simultaneously or in succession (at least partially separately from one another). During the first translational movement, the object can be gripped and rotated. The object can be released again by opening the tong legs. In order for the object to remain in the rotated position, there is preferably no (further) rotation when the object is released. Consequently, the object may be released (only) during the second translational movement of the actuating element.

The actuating element may be adjustable by translational movement between a first end position and a second end position. The tong legs in this case can be opened when the actuating element is in the first end position. In addition, the tong legs can be closable by the first translational movement of the actuating element from the first end position to an intermediate position. If the first translational movement of the actuating element from the intermediate position to the second end position is continued, the tong legs can be rotatable about the axis of rotation.

When the actuating element is in the first end position, the tong legs are preferably opened to the maximum. This means in particular that the gripping ends of the tong legs in the first end position are farther apart from one another than in any other possible position of the actuating element. The actuating element can be moved from the first end position into the second end position by the first translational movement. The actuating element can be moved from the second end position (back) into the first end position by the second translational movement. When the actuating element is moved from the first end position into the second end position by the first translational movement, the tong legs are closed and then rotated (about a predetermined angle of rotation). The tong legs are preferably closed before rotation of the tong legs. The closing of the tong legs can be achieved by the first translational movement of the actuating element from the first end position into the intermediate position. The intermediate position is provided between the first end position and the second end position. The distance between the first end position and the intermediate position is preferably in the range of 40% to 70% of the distance between the first end position and the second end position. For example, the distance can be determined in relation to the translational movement of the actuating element and/or the distance traveled by the guide ends of the tong legs on and/or in the gear mechanism.

The tong legs can be rotated when the actuating element is moved out of the intermediate position and further along the first translational movement (i.e., further in a first direction of movement) toward the second end position. During this rotation, there is preferably no (additional) pivoting of the tong legs toward one another. It is preferable for the tong legs to be openable by the second translational movement of the actuating element from the second end position into the first end position. It is possible for the closing process to last throughout the second translational movement of the actuating element from the second end position to the first end position, but alternatively, it is also possible for the closing process to be concluded in a shorter interval. Then there is preferably no rotation of the tong legs about the axis of rotation.

In the first end position and/or the second end position, the tong legs may form a predefinable opening angle and/or span a predefinable opening angle between them. The opening angle may be adjustable (e.g., repeatedly). In the first (open) end position, the opening angle may be in the range of 25° to 60° [degrees], for example. In the second (closed) end position, the opening angle is smaller, preferably maximally 10° or maximally 5°, but especially preferably greater than 0° or at least 1°. The opening angle can be achieved by a (mechanical) adjustment of the configuration of the function components, for example, the spatial definition of the positions of the actuating element, the guide mandrel, the gear body and/or gear case relative to one another. For this purpose, adjusting elements may be provided, which can adjust and/or lock the axial/translational positioning of the aforementioned parts, for example, by using a form-locking connection. An adjustment of the movement sequence to the food for grilling to be handled can be made easily and expediently by adjusting the opening angle.

The tong legs can be rotated by an angle of rotation in the range of 90° to 270° [degrees]. The angle of rotation is the angle by which the tong legs (and therefore also an object gripped by the tongs) are rotated about the axis of rotation when the actuating element is moved from the first end position into the second end position. The angle of rotation is preferably formed due to the construction of the gear mechanism. Preferably exactly one single angle of rotation from the stated range is preset. If necessary, the gear mechanism may be equipped so that the user can set the individual angle of rotation or can select it from a plurality of (predefined) angles of rotation as needed. The angle of rotation is preferably in a range from 150° to 210° [degrees]. The angle of rotation 180° [degrees] is especially preferred. Rotation by 180° is especially preferred when turning food for grilling on a grill. It is preferably not provided that the tong legs can be rotated by any other angle of rotation than that (a predetermined angle). This makes it possible to achieve a particularly high reproducibility in rotation.

The device may have two tong handles, which are joined to one another and to the actuating element in such a way that the actuating element can be moved translationally by pivoting the tong handles toward one another. The tong handles may be connected to the actuating element by using a linkage, for example. When pivoting the tong handles, the tong handles are opened and/or closed in particular. The tong handles are preferably constructed in the form of a rod. In addition, it is preferable for the tong handles to be joined in the manner of tongs (at a second articulation point in particular). Closing the tong handles preferably produces the first translational movement of the actuating element, and opening the tong handles produces the second translational movement of the actuating element. The user of the device preferably activates the tong handles (exclusively). The actuating element is preferably situated in the first end position when the tong handles are opened to the maximum. The actuating element is preferably in the second end position when the tong handles are closed to the maximum. The object can be gripped and rotated by closing the tong handles. The object can preferably be released by opening the tong handles (without rotation).

The closing process may take place against a (mechanical) resistance, and the opening process may take place with the help of force. The tong handles are preferably connected to one another and to the actuating element in such a way that a restoring force acts on the tong handles in the direction of an opened position of the tong handles. In this case, the user can close the tong handles against the restoring force. The tong legs are opened by the restoring force as soon as the user is no longer counteracting that force. In such an embodiment, the user need not change his or her grip on the handles when switching between opening and closing the tong handles. The restoring force can be produced, for example, by a spring and/or by a pneumatic device situated between the tong handles, in the linkage, in the gear mechanism and/or between the tong legs.

The gear mechanism may have at least one gear body, which is connected to the actuating element and has at least one ramp-type guide, in which the guide ends of the tong legs engage in such a way that the tong legs can be pivoted toward one another by a translational movement of the actuating element. The gear body is preferably fixedly and/or rigidly connected to the actuating element, so that a translational movement of the actuating element produces a translational movement of the gear body. The gear body is preferably held and guided in a gear case. The tong legs preferably have rollers on the guide ends, with which the tong legs engage in the ramp-type guide. When the actuating element is moved between the first end position and the second end position, the guide ends of the tong legs can be moved (by the rollers in particular) along the ramp-type guide, so that the tong legs can be pivoted toward one another. The ramp-type guide is preferably constructed, so that the tong legs are closed by a movement of the actuating element from the first end position into the intermediate position, and the tong legs are opened by a movement of the actuating element from the second end position to the first end position. The ramp-type guide is preferably constructed in the manner of a slotted guide. The gear body is at any rate preferably constructed in the form of a cube in the area of the ramp-type guide. The gear case is preferably constructed to be cylindrical, wherein an axis of the cylinder of the gear case preferably coincides with the axis of rotation. The gear body can therefore rotate in the gear case. With such a slotted guide, the complex movement sequence can be implemented with a small number of parts.

The gear mechanism may have at least one gear body, which is connected to the actuating element and has at least one row of teeth and/or one section of toothed rack, in which the guide ends of the tong legs engage in such a way that the tong legs can be pivoted toward one another by a translational movement of the actuating element. The supported guide ends may therefore have a row of teeth and/or a section of toothed rack. This tooth element variant allows a relatively accurate guidance without high tolerances and/or an unwantedly great play.

The gear body may have at least one rotational guide for rotation of the tong legs about the axis of rotation. Through the use of the rotational guide, the gear body can preferably be rotated together with the tong legs about the axis of rotation. The tong legs are preferably connected to the gear body in a rotationally fixed manner. The actuating element is preferably held rotatably on the gear body. It is possible in this way to achieve the result that the tong legs are rotated while the tong handles are not rotated. The gear body may be constructed to be cylindrical at least in the area of the rotational guide, wherein a cylinder axis of the gear body preferably coincides with the axis of rotation. The rotational guide is preferably constructed in the manner of a slotted guide. For the rotational guide, at least one guide mandrel, which engages in a groove in the gear body, is preferably provided in the gear case. The groove runs around the (cylindrical) gear body preferably completely, so that after the guide mandrel has rotated 360° [degrees], it is again in the location where the guide mandrel was also located at 0°. Rotation of the gear body is thus possible even beyond 360° [degrees] and thus to an unlimited extent. In a translational movement, the gear body is preferably guided by the at least one guide mandrel. The groove in the gear body is preferably constructed so that a translational movement of the actuating element from the first end position to the intermediate position does not cause any rotation. This can be achieved by the fact that the groove in the corresponding section is constructed to be parallel to the axis of rotation. In addition, it is preferable for the groove in the gear body to be constructed so that a translational movement of the actuating element from the intermediate position into the second end position causes rotation of the gear body. This can be achieved by the fact that the groove in the corresponding section at any rate also runs in the circumferential direction of the (cylindrical) gear body. In addition, it is preferable for the groove in the gear body to be constructed so that a translational movement of the actuating element from the second end position into the first end position does not produce any rotation. This can be achieved by the fact that the groove in the corresponding section is constructed to be parallel to the axis of rotation.

Through the use of the rotational guide, the second translational movement of the actuating element is thus preferably not converted as a reversal of the first translational movement. This can be achieved by the fact that the groove has differently shaped branches and/or different depths.

The groove preferably has a first branch and a second branch. In the first branch of the groove, the guide mandrel is preferably guided from the first end position into the second end position, wherein rotation of the tong legs takes place (at any rate between the intermediate position and the second end position). Next, the guide mandrel changes to the second branch of the groove. In the second branch of the groove, the guide mandrel is preferably guided (back) from the second end position to the first end position without any rotation of the tong legs. Next, the guide mandrel preferably changes again to the first branch. At the end positions, the guide mandrel thus preferably changes between the branches, so that the guidance in movement from the first end position to the second end position can take place in a different way than the guidance from the second end position (back) into the first end position. This can be achieved by different depths of the groove. In the first end position, the first branch of the groove preferably has a first depth, and the second branch has a second depth, which is less than the first depth. When the guide mandrel thus reaches the first end position through the second branch, the guide mandrel can change (irreversibly) to the deeper second branch of the groove in the first end position. In the second end position, the first branch of the groove preferably has a third depth, and the second branch has a fourth depth, which is greater than the third depth. When the guide mandrel thus reaches the second end position through the first branch, the guide mandrel can change (irreversibly) to the deeper second branch of the groove in the second end position. In order to compensate for the different depths at the end positions, the depth of the branches of the grooves preferably changes (in particular continuously) between the first end position and the second end position.

In order for the guide mandrel to be able to change into the respective deeper branch of the groove especially well in the end positions, the guide mandrel is preferably held by spring force. This may be achieved, for example, by inserting the guide mandrel into a recess (such as a bore) in the gear case and holding it movably therein. The guide mandrel can then be held by a tension spring spanning the gear case or by a rubber band.

The first depth is preferably between 3.5 mm and 4.5 mm [millimeters] and in particular amounts to approximately 4 mm. The fourth depth preferably corresponds to the first depth. The second depth is preferably between 1.5 mm and 2.5 mm [millimeters] and especially amounts to approximately 2 mm. The third depth preferably corresponds substantially to the second depth.

The groove is preferably subdivided into a first branch and a second branch, so that the first branch and the second branch span the (preferably cylindrical) gear body around the full circumference. Alternatively, it is preferable for the groove to be formed by two or more pairs of first and second branches. A guide mandrel can then pass through the second pair or more pairs, one after the other. For example, if two pairs are provided, one guide mandrel may pass through a first branch of a first pair, then a second branch of the first pair, next a first branch of a second pair, then a second branch of the second pair and next again the first branch of the first pair. A guide mandrel is preferably provided for each pair of a first branch and a second branch. If two pairs of a first branch and a second branch are provided, then the guide mandrels are preferably disposed on opposite sides of the gear case.

The gear body together with a gear case may form a slotted guide for rotation of the tong legs about the axis of rotation, wherein the gear body together with the guide ends of the tong legs forms a slotted guide for pivoting the tong legs toward one another. The slotted guide for rotation of the tong legs is preferably formed by the gear body with the rotational guide and the at least one guide mandrel engaging therewith. The slotted guide for pivoting the tong legs is preferably formed by the ramp-type guide and the guide ends of the tong legs engaging therein.

With the objects of the invention in view, there is also provided a tong configuration, comprising an actuating configuration and a gripper as a preferred application, wherein the actuating configuration is connected to the gripper in such a way that the gripper carries out a gripping movement and a rotational movement by activation of the actuating configuration, and the gripper carries out a movement opposite the gripping movement without rotation and does so by deactivating the actuating device.

The particular advantages and embodiment features presented for the device for gripping and rotating an object are applicable and can be transferred to the tong configuration in any technologically meaningful way and vice-versa.

The tong configuration is preferably intended and equipped for gripping and rotating an object. The object can preferably be gripped by the gripper. In order to do so, the gripper is preferably constructed in the manner of tongs. The gripper can be activated by a user by using the actuating configuration. In the usual application of the tong configuration, the user thus preferably does not activate the gripper directly but instead only activates it indirectly by using the actuating device. The phrase “activating the actuating configuration” is understood in this case to refer to any action by a user of the tong configuration that is intended to open, to close and/or to rotate the gripper (by using the actuating configuration). The actuation of the activating configuration includes in particular the activation and deactivation of the actuating configuration. The activation and deactivation of the actuating configuration are preferably mutually opposite and/or complementary actions. By activating the actuating configuration, the user can grip an object and rotate it. The rotation preferably takes place only after the object has been gripped. By deactivating the actuating device, the user can then release the object without rotating it.

The tong configuration may include a device having the construction proposed herein for gripping and rotating an object. The activating device preferably includes the actuating element. In addition, the actuating device preferably includes the tong handles and preferably also the linkage through the use of which the tong handles are connected to the actuating element. The gripper preferably includes the two tong legs. In addition, the gripper preferably includes the gripping jaws. The functionality described by the tong configuration can be achieved in particular by using the gear mechanism.

With the objects of the invention in view, there is concomitantly provided a method for using the tong configuration described herein (comprising in particular the device described herein for gripping and rotating an object) for gripping and rotating a food item. The tong configuration is preferably used for gripping, rotating and releasing hot food items, such as food for grilling in particular. The special advantages and features of the embodiments presented for the device described herein for gripping and rotating an object can be used and can be applied in any technologically meaningful manner to the method for using of the tong configuration.

The invention and the technical field are described in greater detail below with reference to the figures. The figures show particularly preferred embodiments, although the invention is not limited thereto. In particular, reference is made to the fact that the figures, and in particular the size ratios presented herein, are only diagrammatic. Features illustrated in the figures and/or explained in the text may be extracted and optionally combined with explanations from other figures and/or the preceding description as long as this does not result in a technical contradiction or is explicitly excluded herein.

Other features which are considered as characteristic for the invention are set forth in the appended claims.

Although the invention is illustrated and described herein as embodied in a device for gripping an object, a tong configuration and a method for gripping a food item, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1 to 3 are diagrammatic, longitudinal-sectional views of a tong configuration having a device for gripping and rotating an object in three different positions; and

FIG. 4 is a diagram showing the depth of a groove of a rotational guide of the device for gripping and rotating an object from FIG. 1.

### DETAILED DESCRIPTION OF THE INVENTION

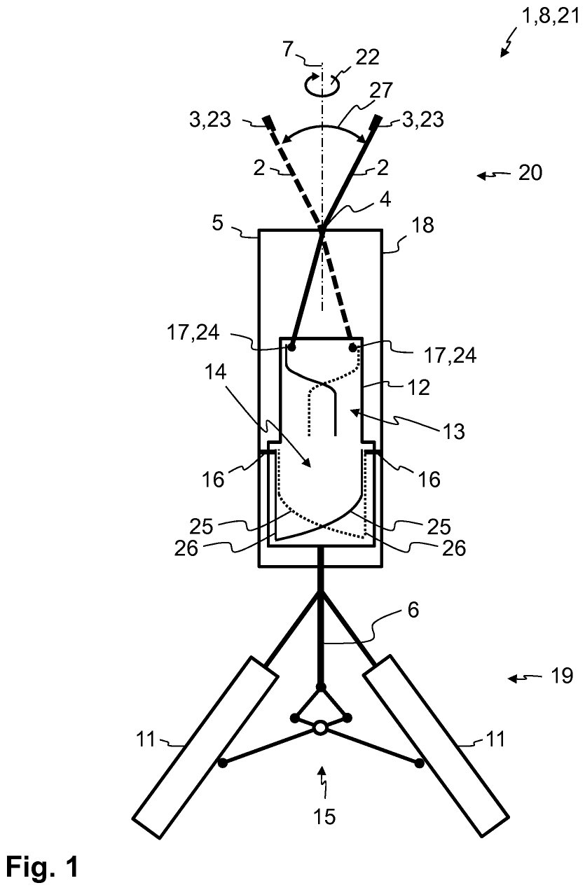

Referring now to the figures of the drawings in detail and first, particularly, to FIGS. 1 to 3 thereof, there is seen a tong configuration 21 with a device 1 for gripping and rotating an object, in particular in the manner of so-called grilling tongs, in three different positions. The device 1 has two tong legs 2 connected to one another at an articulation point 4. For the sake of clarity, one tong leg 2 is shown as a solid line and the other tong leg 2 is shown as a dashed line. The tong legs 2 have a kink at the articulation point 4. The tong legs each have a gripping jaw 23 on gripping ends 3. The object to be gripped can be gripped in the gripping jaws 23. The tong legs 2 and the gripping jaws 23 form a gripper 20 of the tong configuration 21.

The tong legs 2 are connected to a gear mechanism 5. In addition, an actuating element 6 is connected to the gear mechanism 5. A first translational movement of the actuating element 6 is converted by the gear mechanism 5 in such a way that the tong legs 2 can be pivoted toward one another and rotated about an axis of rotation 7 including the articulation point 4. Rotation about the axis of rotation 7 takes place at an angle of rotation 22 of approximately 180° [degrees]. The tong legs 2 are additionally pivotable toward one another by a second translational movement of the actuating element 6 opposite the first translational movement without rotation. In the diagram shown herein, the first translational movement is directed from down to up, and the second translational movement is directed from up to down.

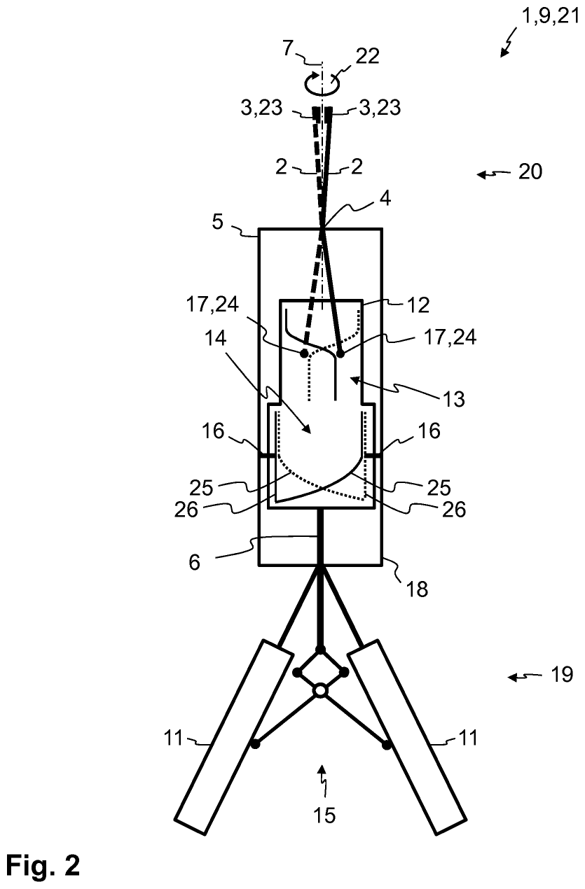

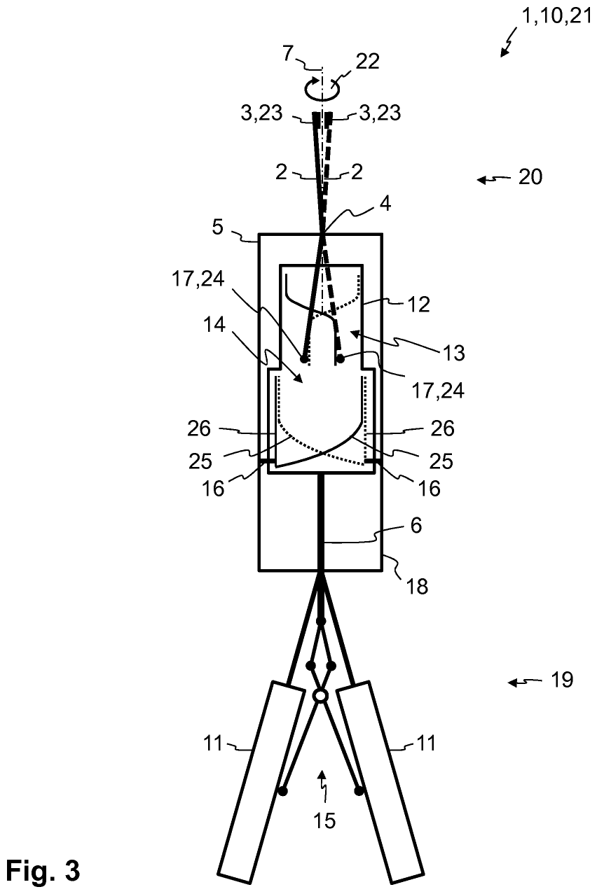

The actuating element 6 is adjustable by translational movement between a first end position 8 (shown in FIG. 1) and a second end position 10 (shown in FIG. 3). The tong legs 2 are open (opening angle 27) when the actuating element 6 is in the first end position 8. The tong legs 2 can be closed by the first translational movement of the actuating element 6 from the first end position 8 into an intermediate position 9 (shown in FIG. 2). In addition, the tong legs 2 can be rotated about the axis of rotation 7 from the intermediate position 9 to the second end position 10 by using the first translational movement of the actuating element 6. The axis of rotation 7 lies in the plane of the tong legs 2 (corresponding to the plane of the paper in this case), runs through the articulation point 4 and runs centrally between the gripping ends 3 of the tong legs 2. The tong legs 2 can be opened by the second translational movement of the actuating element 6 from the second end position 10 into the first end position 8.

The device 1 additionally has two tong handles 11, which are connected to one another and to the actuating element 6 by a linkage 15, so that the actuating element 6 can be brought to a translational movement by pivoting the tong handles 11 toward one another. The tong handles 11 and the linkage 15 form an actuating configuration 19 of the tong configuration 21.

The gear mechanism 5 includes a gear body 12, which is held in a gear case 18. The gear body 12 is connected to the actuating element 6 and has a ramp-type guide 13, in which guide ends 17 of the tong legs 2 engage in such a way that the tong legs 2 can be pivoted toward one another by a translational movement of the actuating element 6. The tong legs 2 therefore have rollers 24 on the guide ends 17. For the sake of clarity, a dotted line is used to show a part of the ramp-type guide 13 with which the tong legs 2, represented by a dashed line, engage. The gear body 12 additionally has a rotational guide 14 for rotation of the tong legs 2 about the axis of rotation 7. The rotational guide 14 has a groove, in which two guide mandrels 16 engage. The groove has two first branches 25 and two second branches 26. For the sake of clarity, one part of a cohesive pair of a first branch 25 and a second branch 26 is represented by a dotted line, and the other part of the pair is represented by a solid line. The guide mandrels 16 can pass through the two pairs, one after the other.

In the first end position 8 (FIG. 1), the tong handles 11 are opened and the actuating element 6 is configured in such a way that the gear body 12 is disposed inside the gear case 18 in the lowest position (in this diagram). The tong legs 2 are opened (to the maximum). If the tong handles 11 are then closed, the actuating element 6 (in this diagram) moves upward due to the linkage 15. The rollers 24 of the tong legs 2 thereby engage in the ramp-type guide 13, so that the tong legs 2 are closed upon reaching the intermediate position 9 (FIG. 2). The guide mandrels 16 engage in the groove of the rotational guide 14 in such a way that no rotation takes place. This is due to the fact that the groove of the rotational guide 14 is constructed to be straight between the first end position 8 and the intermediate position 9 (and runs parallel to the axis of rotation 7). If the tong handles 11 are closed further beyond the intermediate position 9, the tong legs 2 are not pivoted further toward one another. This is due to the fact that the ramp-type guide 13 is constructed to be straight in the area between the intermediate position 9 and the second end position 10, in such a way that a translational movement of the gear body 12 does not cause the tong legs 2 to pivot toward one another. However, the rotational guide 14 causes rotation of the gear body 12 and the tong legs 2 about the axis of rotation 7. This is due to the fact that the groove of the rotational guide 14 is constructed to run peripherally in part around the circumference of the gear body 12, between the intermediate position 9 and the second end position 10. Upon reaching the second end position 10 (FIG. 3), the tong legs 2 are rotated by an angle of rotation 22 of 180° [degrees] in comparison with the first end position 8.

When the tong handles 11 are then opened, the actuating element 6 moves from the second end position 10 to the first end position 8. In doing so, the tong legs 2 are opened without rotating. This can be achieved by the fact that the groove in the rotational guide 14 has branches 25, 26 of different depths.

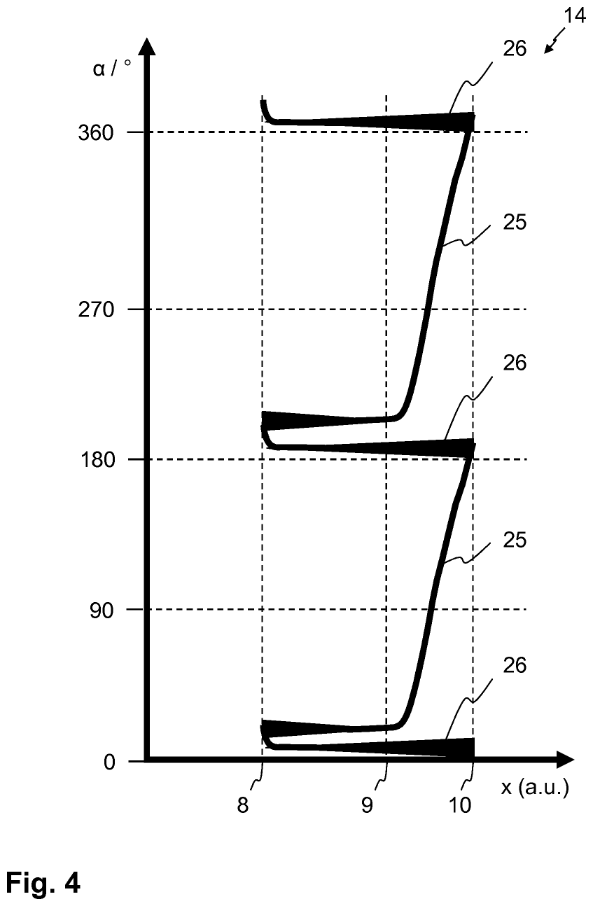

FIG. 4 shows the depth of the groove of the rotational guide 14 of the embodiment of FIGS. 1 to 3. An angle α of rotation of the tong legs 2 about the axis of rotation 7 is plotted on the vertical axis, i.e., the ordinate, in ° [degrees]. A position x of the actuating element 6 in the translational movement between the first end position 8 and the second end position 10 is shown on the horizontal axis, i.e., the abscissa. The position x is shown in arbitrary units, represented by the abbreviation “a.u.” The intermediate position 9 is also shown. In the first end position 8, the first branch 25 of the groove preferably has a first depth, and the second branch 26 has a second depth, which is less than the first depth. In the second end position 10, the first branch 25 of the groove preferably has a third depth, and the second branch 26 has a fourth depth, which is greater than the third depth. In this example, the first depth and the fourth depth each amount to 4 mm [millimeters], and the second depth and the third depth each amount to 2 mm [millimeters].

Assuming that a guide mandrel 6 is situated in the first position 8 and at 0° [degrees] in a first branch 25 of the groove, then by translational movement of the actuating element 6, the guide mandrel 16 can be moved along the first branch 25, whereby the tong legs 2 are rotated (at any rate beyond the intermediate position 9). Upon reaching the second end position 10, the tong legs 2 are rotated by 180° [degrees]. The guide mandrel 6 changes to a second branch 26 of the groove. This can be achieved by the fact that the second branch 26 is deeper at the second end position 10 than the first branch 25. If the actuating element 6 is then moved (back) from the second end position 10 to the first end position 8, the guide mandrel 16 follows the second branch 26. There is no rotation in doing so. In the first end position 8, the guide mandrel 16 changes to the first branch 25. This can be achieved by the fact that the first branch 25 is deeper at the first end position 8 than the second branch 26. By closing the tong handles 11 again, the tong legs 2 can be closed again and thereby rotated by another 180° [degrees]. The tong legs 2 can then be opened again without rotation by opening the tong handles 11 again. This process can be repeated as often as desired.

The following is a summary list of reference numerals and the corresponding structure used in the above description of the invention:
1 Device
2 Tong leg
3 Gripping end
4 Articulation point
5 Gear mechanism
6 Actuating element
7 Axis of rotation
8 First end position
9 Intermediate position
10 Second end position
11 Tong handle
12 Gear body
13 Ramp-type guide
14 Rotational guide
15 Linkage
16 Guide mandrel
17 Guide ends
18 Gear case
19 Actuating configuration
20 Gripper
21 Tong configuration
22 Angle of rotation
23 Gripping jaw
24 Roller
25 First branch
26 Second branch
27 Angle of opening

1. A device for gripping and rotating an object, the device comprising:
two tong legs connected to one another at an articulation point;
a gear mechanism connected to said two tong legs; and
an actuating element connected to said gear mechanism;
said gear mechanism converting a first translational movement of said actuating element into pivoting of said tong legs toward one another and rotation of said tong legs about an axis of rotation including said articulation point.

2. The device according to claim 1, wherein said gear mechanism converts a second translational movement of said actuating element opposite said first translational movement into pivoting of said tong legs toward one another without rotation.

3. The device according to claim 1, wherein:
said actuating element is adjustable by said translational movement between a first end position and a second end position;
said tong legs are opened when said actuating element is in said first end position;
said tong legs are closed by said first translational movement of said actuating element from said first end position into an intermediate position; and
said tong legs are additionally rotatable about said axis of rotation by said first translational movement of said actuating element from said intermediate position into said second end position.

4. The device according to claim 1, wherein said tong legs are rotatable by an angle of rotation in a range of 90° to 270° [degrees].

5. The device according to claim 1, which further comprises two tong handles being connected to one another and to said actuating element for carrying out said translational movement of said actuating element by pivoting said tong handles toward one another.

6. The device according to claim 1, wherein:
said tong legs have guide ends;
said gear mechanism includes at least one gear body connected to said actuating element; and
said at least one gear body has at least one ramp-shaped guide in which said guide ends engage for pivoting said tong legs toward one another by said translational movement of said actuating element.

7. The device according to claim 6, wherein said gear body additionally has at least one rotational guide for rotating said tong legs about said axis of rotation.

8. The device according to claim 7, wherein:
said gear mechanism includes a gear case;
said gear body together with said gear case forms a slotted guide for rotation of said tong legs about said axis of rotation; and
said the gear body together with said guide ends of said tong legs forms a slotted guide for pivoting said tong legs toward one another.

9. A tong configuration, comprising:
a gripper; and
an actuating configuration connected to said gripper;
said actuating configuration being activated for causing said gripper to carry out a gripping movement and a rotational movement; and
said actuating configuration being deactivated for causing said gripper to carry out a movement opposing said gripping movement without a rotational movement.

10. The tong configuration according to claim 9, which further comprises a device for gripping and rotating an object, the device including:
two tong legs connected to one another at an articulation point;
a gear mechanism connected to said two tong legs; and
an actuating element connected to said gear mechanism;
said gear mechanism converting a first translational movement of said actuating element into pivoting of said tong legs toward one another and rotation of said tong legs about an axis of rotation including said articulation point.

11. A method for using a tong configuration, the method comprising using the tong configuration according to claim 9 for gripping and rotating a food item.
